(19) United States
(12) Patent Application Publication
(10) Pub. No.: US 2015/0231993 A1
(43) Pub. Date: Aug. 20, 2015

(54) VEHICLE SEAT

(71) Applicants: TS TECH CO., LTD., Asaka-shi,Saitama (JP); IMASEN ELECTRIC INDUSTRIAL CO., LTD., Inuyama-shi, Aichi (JP)

(72) Inventors: Masayuki Hoshi, Tochigi (JP); Masami Yoshida, Tochigi (JP); Takuto Esaki, Inuyama-shi (JP); Takashi Yashiro, Inuyama-shi (JP)

(73) Assignees: TS TECH CO., LTD., Asaka-shi,Saitama (JP); IMASEN ELECTRIC INDUSTRIAL CO., LTD., Inuyama-shi, Aichi (JP)

(21) Appl. No.: 14/429,630

(22) PCT Filed: Sep. 21, 2012
(86) PCT No.: PCT/JP2012/074304

§ 371 Date: Mar. 19, 2015

(51) Int. Cl. B60N 2/16; B60N 2/68

(52) U.S. Cl. CPC B60N 2/1615; B60N 2/165; B60N 2/68

(57) ABSTRACT

A vehicle seat achieves support rigidity of a height link mechanism coupled to a side frame that enables restraints of shaft misalignment between a drive shaft of a height brake and that of a sector gear portion. The vehicle seat includes side frames and a frame coupling member that couples the side frames together. An attachment member including a brake support portion that supports the drive shaft of the height brake is attached to the right and left insides of the right and left side frames. In the attachment member, a region located in back of the brake support portion is a region supported by the frame coupling member, and a region located in front of the brake support portion is a front frame coupling portion that is coupled to the side frames, whereby the attachment member is attached to the side frames.

### CROSS REFERENCE TO RELATED APPLICATIONS

This application is a National Stage Entry application of PCT Application No. PCT/JP2012/074304, filed Sep. 21, 2012.

### BACKGROUND

Disclosed herein is a vehicle seat, in particular, a vehicle seat that includes a height link mechanism enabling adjustment of the height level of the vehicle seat.

Various proposals are conventionally made in which adjustment for the height level of a vehicle seat is enabled by providing a height link mechanism to the vehicle seat.

The height link mechanism, which is located, e.g., between a support base fixedly attached to a vehicle body and the vehicle seat, includes a pair of front links on the front right and front left sides of the seat, and a pair of rear links on the rear right and rear left sides of the seat. The mechanism is configured such that either one of the rear links serves as a drive link to enable adjustment of the height level of the seat. Further, provided in a right and left direction outside the drive link is an operating lever for operating drive of the height link mechanism, and provided between the drive link and the operating lever is a height brake that controls the drive of the height link mechanism. What is disclosed in Japanese Patent Document No. 2011-246024 A (“the '024 Document”) is known as a vehicle seat that includes such a height link mechanism.

The vehicle seat disclosed in the '024 Document includes a height link mechanism that liftably and lowerably couples a seat cushion to a support base. As shown in FIG. 6, this height link mechanism includes a pair of front links coupled to the front end portion and a pair of rear links 101 coupled to the rear end portion relative to a pair of side frames 100, disposed at both right and left end portions, that each serve as a framework of the seat cushion.

Of the right and left rear links 101, a right rear link 102 serves as the drive link of the height link mechanism, and a sector gear portion 103 is formed in a portion of the periphery of the right rear link 102.

The sector gear portion 103 is disposed to be engaged with a pinion gear 104 pivotally supported by the side frame 100. The pinion gear portion 104 is coupled via a drive shaft to an operating lever 105 provided outside the side frame 100.

Additionally, provided between the side frame 100 and the operating lever 105 is a height brake 106, which has a mechanism that retains the position of the operating lever 105 during non-operation of the lever 105.

Thus, by lifting up the operating lever 105, the pinion gear 104 is positively rotated to elevate the seat cushion via the sector gear portion 103. In addition, by pressing down the operating lever 105, the pinion gear 104 is reversely rotated to lower the seat cushion via the sector gear portion 103.

Further, a support arm 107 is provided inside the side frame 100 in the right and left direction. The support arm 107 is configured to be fixedly coupled at its front portion 108 to the side frame 100, to be fixedly coupled at its rear portion 109 to the side frame 100 in a manner to sandwich the right rear link 102, and to support at its middle portion 110 the drive shaft of the pinion gear 104 and the height brake 106. The attachment of the support arm 107 enhances support rigidity of the height link mechanism, as well as enhancing rigidity of the side frame 100.

However, although in a vehicle seat including a height link mechanism as in the '024 Document, support rigidity of the height link mechanism coupled to a side frame 100 is enhanced by providing a support arm 107 inside the side frame 100, a demand has recently been made for rigidity of the height link mechanisms by which, other than a load applied when a passenger is seated, a load such as an impact load during vehicle collision also cause no deformation. And the support rigidity of the height link mechanism has been desired to be achieved, in particular, the support rigidity that is capable of restraining shaft misalignment between the drive shaft of the height brake and that of the sector gear portion of the link.

Further, in the vehicle seat as in the '024 Document, a right rear link 102 has been coupled to a height brake 106 via a sector gear portion 103 and a pinion gear portion 104, while the other left rear link has been only pivotally supported by the side frame 100. For that reason, other than the load applied when the passenger is seated, the impact load applied during vehicle collision causes a vehicle seat to depresses at its one side when the load is concentrated in the other side frame 100, and thereby there has been a possibility that right and left rear links 101 will not smoothly work together.

For this reason, vehicle seats have been desired in which an attachment member is fixedly attached to the inside of one side frame, to support drive shafts of the height brake and the pinion gear, the attachment member being coupled by a coupling pipe to the other side frame, thereby enhancing rigidity of the entire right and left side frames. At the same time, vehicle seats have been desired in which rigidity of the attachment member is achieved.

In addition, in the vehicle seat as in the '024 Document, the support rigidity of the height link mechanism is enhanced by providing the support arm 107 to the side frame 100; however, because of the load such as the impact load applied during vehicle collision, other than the load applied when the passenger is seated, a great force acts on a place where the sector gear portion 103 and the pinion gear 104 are engaged, there is a possibility that the sector gear portion 103 inclines axially in a right and left direction and is out of engagement with the pinion gear 104, thus lowering the strength.

For this reason, vehicle seats have been desired which include the height link mechanism that enables restraints of deformation caused by the sector gear portion of the rear link being out of engagement with the pinion gear.

### SUMMARY

Various embodiments of the present invention are made in light of the above described problems, and an object thereof is to provide a vehicle seat in which the support rigidity is achieved of the height link mechanism coupled to the side frame, in particular, the support rigidity is achieved that enables restraints of shaft misalignment between the drive shaft of the height brake and that of the sector gear portion.

Another object is to provide vehicle seats in which the attachment member is fixedly attached to the inside of one side frame and supports drive shafts of the height brake, the attachment member being coupled by the coupling pipe to the other side frame, thereby enhancing rigidity of the entire right and left side frames. At the same time, it is to provide vehicle seats in which the rigidity of the attachment member is achieved.

Another object is to provide vehicle seats including the link mechanism that enables restraints of deformation caused by the sector gear portion of the rear link being out of engagement with the pinion gear.

The foregoing problems are solved by the fact that, according to a vehicle seat disclosed herein, a vehicle seat comprises: a height link mechanism liftably and lowerably couples a seat cushion to a support base attached to the vehicle body, the seat cushion including a side frame disposed at both its right and left ends, and a cushion frame that has a frame coupling member coupling the right and left side frames, and the height link mechanism including a link that couples the support base and the side frame together, and a height brake that controls lifting and lowering of the seat cushion, wherein an attachment member including a brake support portion that supports a drive shaft of the height brake is attached to the right and left inside of the side frame, and wherein, in the attachment member, a region located in back of the brake support portion is a region supported by the frame coupling member, and a frame fastening portion fastened to the right and left inside of the side frame is provided in a region located in front of the brake support portion.

The vehicle seat thus comprises a height link mechanism, and the height link mechanism includes a link that couples a support base and a side frame together; and a height brake that controls lifting and lowering of a seat cushion, and an attachment member including a brake support portion that supports a drive shaft of the height brake is attached to the right and left inside of the side frame and therefore, the provision of this attachment member can provide a vehicle seat in which support rigidity is achieved of the height link mechanism coupled to the side frame, in particular, support rigidity is achieved that enables restraints of shaft misalignment between a drive shaft of the height brake and that of the link.

In addition, because, in the attachment member, a region located in back of the brake support portion is a region supported by a frame coupling member, and a frame fastening portion fastened to the right and left inside of a side frame is provided in a region located in front of the brake support portion, the attachment member is fixedly attached to the inside of one side frame and supports drive shafts of the height brake, and is coupled by the frame coupling member to the other side frame, thereby enhancing rigidity of the entire right and left side frames.

Further, because, in the attachment member, the region located in back of the brake support portion is the region supported by the frame coupling member, and the frame fastening portion fastened to the right and left inside of the side frame is provided in the region located in front of the brake support portion, rigidity of the entire attachment member, in particular, rigidity of the brake support portion within the attachment member, can be enhanced.

It is adequate if the attachment member includes a flange portion that protrudes inward in a right and left direction in a region where the frame fastening portion is included, and a region that is located below as viewed from the brake support portion; if the flange portion includes a first flange portion, and a second flange portion having a smaller amount of protrusion extending inward in the right and left direction than the first flange portion; and if the first flange portion is provided below the region where the frame fastening portion is included, and the second flange portion is provided below the brake support portion.

Because the attachment member thus includes the flange portion protruding inward in the right and left direction, in a region where a frame fastening portion is included and a region that is located below as viewed from a brake support portion, rigidity of the entire attachment member, in particular, rigidity of the brake support portion within the attachment member can be enhanced.

Further, because the second flange portion having the smaller amount of protrusion extending inward in the right and left direction than the first flange portion, is provided below the brake support portion, even when a seat cushion reaches the lowest level by way of a height link mechanism, interference of the flange portion with other constituent elements can be restrained in a region, within the attachment member, located below the brake support portion.

It is adequate if the frame fastening portion is made up of a first frame fastening portion and a second frame fastening portion, and the attachment member includes the first frame fastening portion that fastens to the side frame, between the second frame fastening portion and the frame coupling member in the front to back direction.

This configuration can enhance support rigidity of a side frame, support rigidity of a height link mechanism coupled to the side frame, and rigidity of the entire attachment member attached to the inside of the side frame.

It is adequate if the link includes a sector gear portion in at least a portion of its periphery, and if the attachment member includes a third flange portion protruding inward in the right and left direction, at a position opposite the sector gear portion in the right and left direction.

Because of this configuration, rigidity can be enhanced by providing a flange portion in a region, within the attachment member, located opposite the sector gear portion of the link in the right and left direction.

Further, the placement is such that the attachment member not only supports the drive shaft of the height brake, but also supports the sector gear portion of the link. As a result, the attachment member can restrain deformation occurring by a sector gear portion of the rear link being out of engagement with the pinion gear that is engaged with the sector gear portion.

It is adequate if an upwardly protruding bead of projection shape is provided below as viewed from the brake support portion and the first frame fastening portion.

Because of such a configuration, rigidity of the entire attachment member, in particular, in the brake support portion can be enhanced by way of the bead.

It is adequate if, within the side frame, a region fastened to the frame fastening portion is depressed inward in the right and left direction and formed into a recess, and if the height brake is joined to the side frame on the side opposite the frame fastening portion in the right and left direction, and a region, within the height brake, joined to the side frame is located astride the recess.

Since the attachment member is, thus, fastened at a position, within the inside surface of the side frame, of the recess depressed inward in the right and left direction, rigidity of the side frame can further be enhanced in a region where the recess supported by the attachment member is included.

Further, since the height brake is joined to the side frame on the side opposite the frame fastening portion in the right and left direction, and the region, within the height brake, joined to the side frame is placed astride the recess, the height brake is joined to the place, within the outside surface of the side frame, located astride the recess having higher rigidity resulting from being supported by the attachment member, whereby the support rigidity of the height brake can be enhanced.

At this time, it is adequate if the attachment member is attached between the upper end and the lower end of the side frame.

Because of such a configuration, the attachment member is attached to the side frame in a compact arrangement, and thereby the support rigidity can be achieved of the height link mechanism coupled to the side frame, in particular, the support rigidity can be achieved that is capable of restraining shaft misalignment between the drive shaft of the height brake and that of the sector gear portion of the rear link.

According to an embodiment, a vehicle seat comprises a height link mechanism, the height link mechanism including a link that couples the support base to the side frame, and a height brake that controls lifting and lowering of the seat cushion, wherein an attachment member including a brake support portion that supports a drive shaft of the height brake is attached to the right and left inside of the side frame and therefore, the provision of the attachment member can provide a vehicle seat in which support rigidity is achieved of the height link mechanism coupled to the side frame, in particular, support rigidity is achieved that enables restraints of shaft misalignment between a drive shaft of the height brake and that of the link.

In addition, because, in an attachment member, a region located in back of a brake support portion is a region supported by a frame coupling member, and a frame fastening portion fastened to the right and left insides of a side frame is provided in a region located in front of a brake support portion, an attachment member is fixedly attached to the inside of one side frame and supports drive shafts of the height brake, and is coupled by a frame coupling member to the other side frame, thereby enhancing rigidity of the entire right and left side frames.

Further, because, in the attachment member, the region located in back of the brake support portion is the region supported by the frame coupling member, and a frame fastening portion fastened to the right and left inside of the side frame is provided in the region located in front of the brake support portion, the rigidity of the entire attachment member, in particular, the rigidity of the brake support portion within the attachment member can be enhanced.

According to an embodiment, because, in a region where a frame fastening portion is included and a region that is located below as viewed from a brake support portion, the attachment member includes the flange portion protruding inward in the right and left direction, rigidity of the entire attachment member, in particular, rigidity of the brake support portion within the attachment member can be enhanced.

Further, because the second flange portion having a smaller amount of protrusion extending inward in the right and left direction than the first flange portion is provided below the brake support portion, even when a seat cushion reaches the lowest level by way of a height link mechanism, interference of the flange portion with other constituent elements can be restrained in a region, within the attachment member, located below the brake support portion.

According to an embodiment, support rigidity of a side frame, support rigidity of a height link mechanism coupled to the side frame, and rigidity of the entire attachment member attached to the inside of the side frame, can be enhanced.

According to an embodiment, rigidity can be enhanced by providing a flange portion in a region, within the attachment member, located in the right and left direction opposite the sector gear portion of the link.

Further, the placement is such that the attachment member not only supports the drive shaft of the height brake, but also supports the sector gear portion of the link. As a result, the attachment member can restrain deformation occurring by a sector gear portion of the rear link being out of engagement with the pinion gear that is engaged with the sector gear portion.

According to an embodiment, rigidity of the entire attachment member, in particular, in the brake support portion, can be enhanced by way of the bead.

According to an embodiment, because the attachment member is coupled at a position, within the inside surface of the side frame, of the recess depressed inward in the right and left direction, rigidity of the side frame can further be enhanced in a region where the recess supported by the attachment member is included.

Further, because the height brake is joined to the side frame on the side opposite the frame fastening portion in the right and left direction, and a region, within the height brake, joined to the side frame is placed astride the recess, the height brake is joined to a place, within the outside surface of the side frame, located astride the recess having higher rigidity resulting from being supported by the attachment member, whereby the support rigidity of the height brake can be enhanced.

According to an embodiment, the attachment member is attached to the side frame in a compact arrangement, and thereby the support rigidity can be achieved of the height link mechanism coupled to the side frame, in particular, the support rigidity can be achieved that is capable of restraining shaft misalignment between the drive shaft of the height brake and that of the sector gear portion of the rear link.

### BRIEF DESCRIPTION OF THE DRAWINGS

FIG. 1 is a schematic perspective view of a vehicle seat according to an embodiment of the present invention;

FIG. 2 is a schematic perspective view of a cushion frame of a seat cushion according to an embodiment of the present invention;

FIG. 3 is an enlarged perspective view of a relevant portion illustrating a left attachment member within the cushion frame of FIG. 2;

FIG. 4 is an enlarged perspective view of the relevant portion illustrating a right attachment member within the cushion frame of FIG. 2;

FIG. 5 is a schematic perspective view of the cushion frame of FIG. 2, as viewed from a different angle; and

FIG. 6 is a perspective view illustrating a vehicle seat of a related art that includes a height link mechanism.

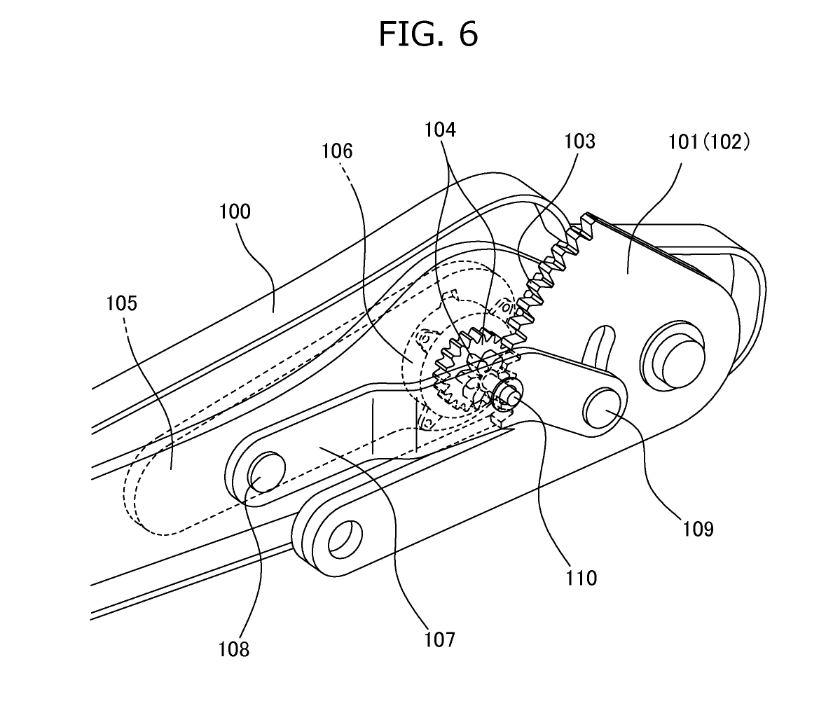

### DETAILED DESCRIPTION

An embodiment according to the present invention will be described hereinafter with reference to the drawings. The invention is not limited by members, placements, and the like, as will be described below, and they may be modified in various ways in accordance with the spirit of the invention.

The present embodiment pertains to the invention of a vehicle seat that includes a height link mechanism that is characterized by the fact that an attachment member is provided on the right and left insides of side frames of a seat cushion, and the attachment member is caused to support a drive shaft of a height brake.

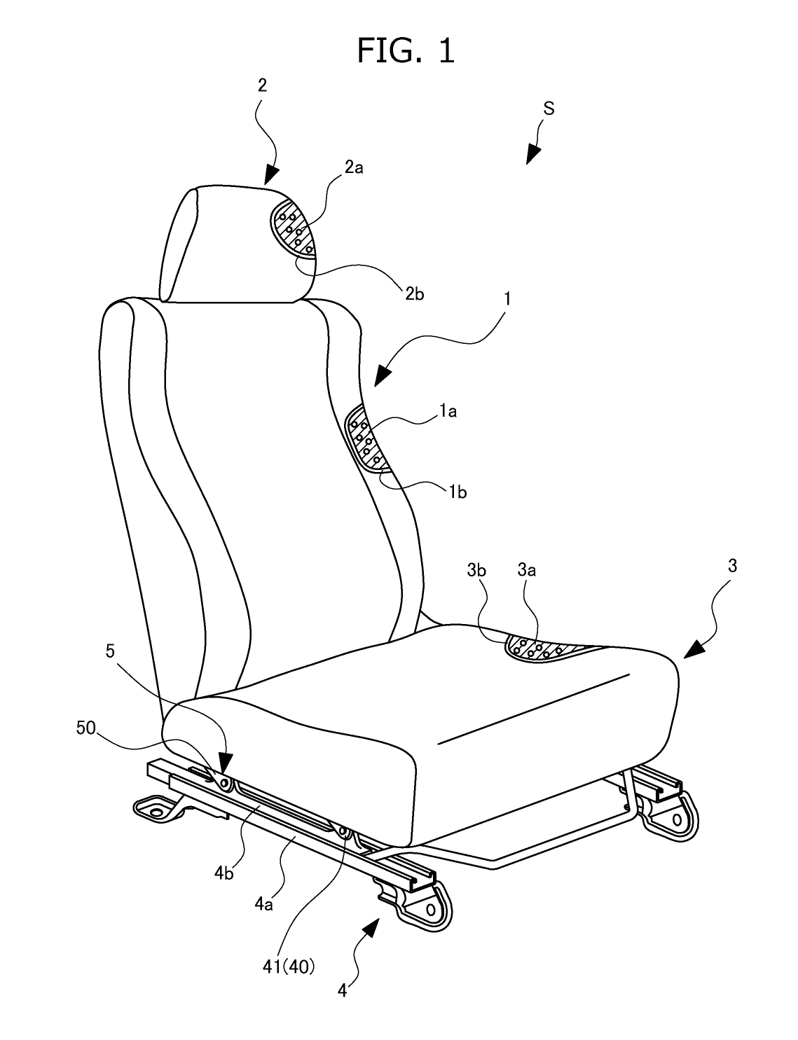

A vehicle seat S according to the present embodiment is generally constituted of a seat back 1, a headrest 2 disposed on the top face of the seat back 1, and a seat cushion 3 disposed on the front side of the seat back 1, as shown in FIG. 1.

With respect t to the seat back 1 of the vehicle seat S, the side where a passenger is seated is referred to as the front side.

The seat back 1, which is a backrest that supports the back of the passenger from behind, is configured to be covered with a skin 1b with a cushion pad 1a placed in a seat back frame, not shown, serving as a framework.

The headrest 2, which is a top portion that support the head of the passenger from behind, is formed by being covered with a skin 2b with a cushion pad 2a disposed in a pillar, not shown, serving as a core.

The seat cushion 3, which is a seating portion that supports the passenger from below, is configured by being covered over a cushion pad 3a with a skin 3b, with the cushion pad placed in a cushion frame 10 serving as the framework.

The cushion frame 10 is supported by a rail mechanism 4 and the rail mechanism 4 has a lower rail 4a fixedly attached to the floor of car body, an upper rail 4b slidably movable on the lower rail 4a in the front to back direction in engagement with the lower rail 4a, as shown in FIG. 1.

The rail mechanism 4 corresponds to the support base in the scope of the claims.

Further, provided between the cushion frame 10 and the rail mechanism 4 is a height link mechanism 5 that adjusts the height level of the vehicle seat S.

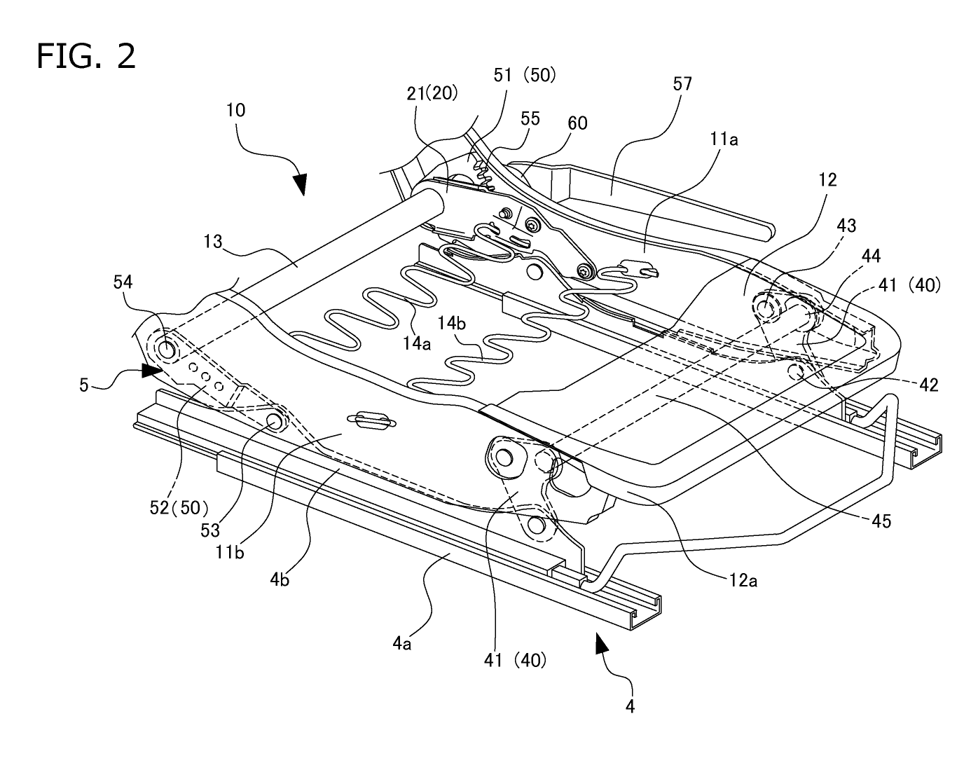

The height link mechanism 5 includes a link 40 that couples the cushion frame 10 and the upper rail 4b together, as shown in FIG. 2. The link 40 includes a pair of front links 41 on its front right and front left sides, and a pair of rear links 50 on its rear right and rear left sides. The link mechanism is configured such that of the rear links 50, a left rear link 51 on the left side serves as a drive link and enables adjustment of the height level of the seat cushion 3. Further, provided in the right and left direction outside the left rear link 51 is an operating lever 57 for operating drive of the height link mechanism, and provided between the left rear link 51 and the operating lever 57 is a height brake 60 that controls the drive of the height link mechanism.

The cushion frame 10, which is made up of a substantially rectangular frame that serves as a framework of the seat cushion 3, includes, as shown in FIG. 2, right and left side frames 11 disposed in the respective right and left ends, a pan frame 12, serving as a plate-shaped frame, disposed astride the top surface of the front side of each side frame 11, a frame coupling member 13, serving as a coupling member, disposed astride the neighborhood of the rear end portion of each side frame 11, and an elastic member 14 that couples the substantially middle portion in the front to back direction of each side frame 11.

Each side frame 11 is made up of a sheet metal member extending in the front to back direction, and the left side frame 11a on the left side and the right side frame 11b on the right side are separated in parallel in the right and left direction from each other.

The pan frame 12 extending in the right and left direction is fixedly coupled to the front side top surface of each side frame 11.

The pan frame 12 is made up of a metal frame that supports the thigh of the passenger, and its top surface is formed into substantially flat and rectangular shape.

The pan frame 12 has a pair of bends 12a at both end portions on the front side and in the right and left direction. In the pan frame 12, each bend 12a is hooked on the front top surface of each side frame 11, and the bottom surface on the right and left end portions of the pan frame 12 is fastened and joined to the top surface on the front side of each side frame.

The frame coupling member 13 extending in the right and left direction is fixedly coupled to the right and left inside surfaces of the rear end portion of each side frame 11.

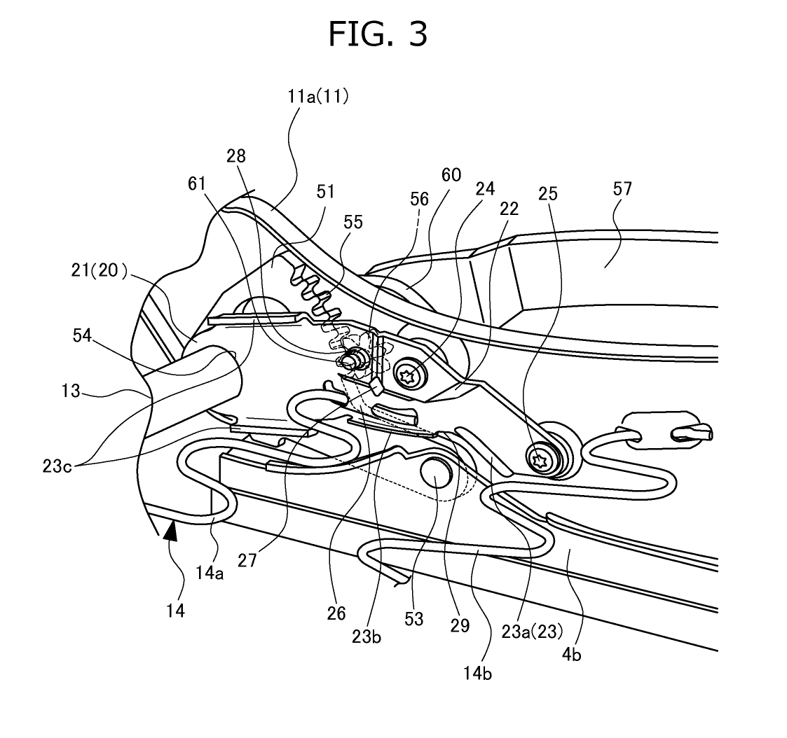

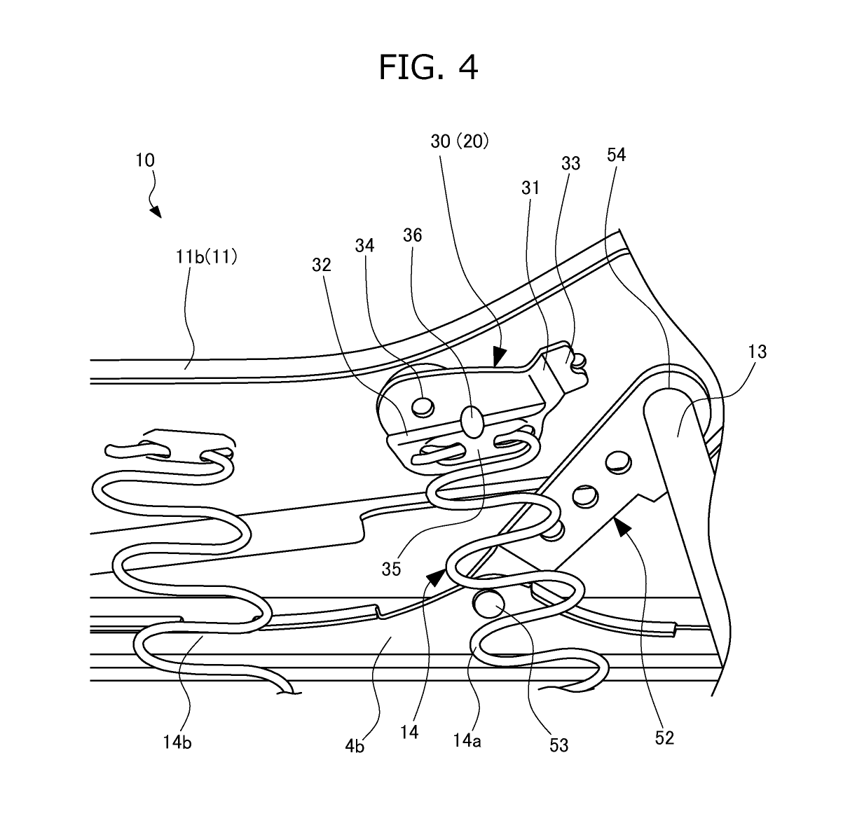

The frame coupling member 13 is made up of a pipe member, of substantially circle-shaped cross-section, that couples the right and left side frames 11 together. The left end of the frame coupling member 13 is coupled to the left side frame 11a via an attachment member 20 attached in the inside surface in the right and left direction of the left side frame 11a, as shown in FIG. 3. The right end portion of the frame coupling member 13 is coupled via a right rear link 52 to the right side frame 11b, as shown in FIG. 4.

In the substantially middle in the front to back direction of each side frame 11, and between the pan frame 12 and the frame coupling member 13 in the front to back direction, a plurality of elastic members 14 are disposed at predetermined intervals in the front to back direction, and meanderingly extend substantially in parallel with each other in the right and left direction.

Each elastic member 14 is an elastic spring that supports the cushion pad 3a from below, and is made up of a wavy line-shaped member called an S spring or a zigzag spring.

Although the elastic member 14 according to the present embodiment is made up of an elastic spring, but without being limited to this, an elastic body such as an elastic rubber may be employed instead.

Of the elastic members 14, a first elastic member 14a provided on the rear side is coupled to the right and left side frames 11 by causing its right and left end portions to be hooked to the attachment members 20 attached to the inside surfaces of the right and left side frames 11, as shown in FIG. 3 and FIG. 4.

A second elastic member 14b provided further forward than the first elastic member 14a is coupled to the right and left side frames 11 by causing its right and left end portions to be hooked to the inside surfaces of the right and left side frames 11, as shown in FIG. 2.

Specifically, recesses depressed inward in the right and left direction are provided on the inside surfaces of the right and left side frames 11, and through holes passing through in the front to back direction are provided at the right and left inside end portion of each recess. The second elastic member 14b is coupled to the right and left side frames 11 by causing its right and left ends to be inserted in and hooked to the through holes.

Although, in the present embodiment, the second elastic member 14b is coupled to the inside surfaces of the right and left side frames 11, the second elastic member 14b may be hooked to the attachment members 20, as with the first elastic member 14a, in another embodiment.

In that case, the attachment member 20 is to be formed to extend further in the front to back direction, and its end portion located further forward than the second elastic member 14b is to be fixedly coupled to each side frame 11.

The second elastic member 14b is thus configured to be coupled via the attachment member 20 to each side frame 11, whereby the second elastic member 14b is also enabled to be set to provide appropriate elastic deformation, as compared to the case where the elastic member is directly coupled to each side frame 11. For that reason, appropriate adjustments can be made to increase comfort of a passenger to be seated.

Since the first elastic member 14a is hooked to the attachment members 20 attached to the insides of the right and left side frames 11 in the right and left direction, the length in the right and left direction of the first elastic member 14a can be shortened, as compared to the case where the elastic member is attached to each side frame 11.

Further, the length of the first elastic member 14a is made short in order to retain the amount of elastic deformation in the up to down direction of the first elastic member 14a, and the diameter of the member can be made smaller accordingly.

For this reason, the first elastic member 14a can be disposed compactly inside the right and left side frames 11, and in addition, material costs for the first elastic member 14a can be reduced.

The attachment members 20 are sheet-metal members to which the elastic members 14 are attachable in a manner not to interfere with other constituent elements, as well as to enhance the rigidity of the side frame 11, and extends in the front to back direction, as shown in FIG. 3 and FIG. 4.

The attachment members 20, which are located between the upper ends and the lower ends of the right and left side frames 11 in the up to down direction, are attached on the surfaces on the right and left insides of the frames, and are constituted of a left side attachment member 21 attached to the inside surface of the left side frame 11a, and a right side attachment member 30 attached to the inside surface of the right side frame 11b.

The left side attachment member 21 is bent in the form of a crank as shown in FIG. 3, and is formed such that its rear side portion protrudes inward in the right and left direction more than its front side portion, via a step surface portion 22 bent at a place located toward the front portion from the middle portion.

The left side attachment member 21 includes a flange portion 23 that protrudes inward in the right and left direction; the flange portion 23 is constituted of a front flange portion 23a, a middle flange portion 23b, and rear flange portions 23c.

The front flange portion 23a is provided at the lower end portion on the front side; the middle flange portion 23b is provided at the middle lower end portion in the front to back direction; and the rear flange portions 23c are provided at both up and down end portions on the rear side. The front flange portion 23a protrudes inward in the right and left direction greater than the middle flange portion 23b; the rear flange portions 23c protrude inward in the right and left direction much greater than the front flange portion 23a.

The front flange portion 23a corresponds to a first flange portion in the embodiments; the middle flange portion 23b corresponds to a second flange portion in the embodiments; and the rear flange portion 23c corresponds to a third flange portion in the embodiments.

The amounts of protrusion of the front flange portion 23a, the middle flange portion 23b and the rear flange portion 23c that extend inward in the right and left direction may be varied without being limited to them. By increasing the amount of protrusion of each flange portion 23, the rigidity of region where each flange 23 is included is enabled to be enhanced.

Further, when the seat cushion 3 is lifted and lowered by the height link mechanism 5, an additional flange portion may be provided, or this flange portion may be disposed protruding outward in the right and left direction, within the range in which each flange portion 23 does not interfere with other constituent elements in the region where each flange portion 23 is included.

The left side attachment member 21 is made up of a middle frame fastening portion 24, and a front frame fastening portion 25, for coupling the attachment member to the left side frame 11a; a region where the frame coupling member 13 is coupled; a spring locking portion 26 for coupling thereto the left end portion of the first elastic member 14a; and a brake support portion 28 that supports the drive shaft of the height brake 60.

The middle frame fastening portion 24 corresponds to a first frame fastening portion in the embodiments; the front frame fastening portion 25 corresponds to a second frame fastening portion in the embodiments.

As shown in FIG. 3, the middle frame fastening portion 24, which is at a position, within the left side attachment member 21, located toward the front from substantially the middle in the front to back direction, is provided above the middle flange portion 23b, and is caused to abut against and is secured by fastening bolt to a recess, depressed inward in the right and left direction, that is on the inside surface of the left side frame 11a.

The front frame fastening portion 25, which is at a front end portion, within the left side attachment member 21, located more forward than the middle frame fastening portion 24, is provided above the front flange portion 23a and is caused to abut against and is secured by a fastening bolt to a recess, depressed inward in the right and left direction, that is the inside surface of the left side frame 11a.

The middle frame fastening portion 24 and the front frame fastening portion 25 are secured by a fastening bolt to the inside surface of the left side frame 11a, but without being limited to this, for example, they may be secured by welding, in particular, secured by laser welding. Securing them this way enables reduction of parts count.

A region where the frame coupling member 13 is coupled, which is at the rear end portion of the left side attachment member 21, is provided between the rear flange portions 23c in the up to down direction, and is caused to abut against and secured by welding to the left end portion of the frame coupling member.

The frame coupling member 13 is secured by welding to the left side attachment member 21, but without being limited to this, the coupling member may be coupled by a fastening bolt. Coupling it this way results in easy-to-disassemble construction.

The spring locking portion 26, which is at the substantially middle position, within the left side attachment member 21, located between the front frame fastening portion 25 and the frame coupling member 13, in the front to back direction is provided between the middle frame fastening portion 24 and the middle flange portion 23b in the up to down direction, and includes a bend, bent in the right and left direction, that protrudes inward in the right and left direction.

The spring locking portion 26 is coupled to the first elastic member 14a by inserting the left end portion of the first elastic member 14a into a region surrounded by a bend, in other words, into the through hole passing through in the front to back direction and by locking them together.

The left side attachment member 21 includes a bead 27 of projection shape that protrudes upwardly from the top surface of the spring locking portion 26, which fact enhances support rigidity of the spring locking portion 26.

In the middle flange portion 23b provided below the spring locking portion 26, the amount of protrusion that extends inward in the right and left direction is set to be small.

For this reason, the first elastic member 14a can be formed to not interfere with the middle flange portion 23b of the attachment member 20 when the elastic member undergoes elastic deformation in the up to down direction in order to support a seated passenger from below.

The bead 27 is provided on the top surface of the spring locking portion 26, but without being limited to this, the bead may be provided on the bottom surface of the spring locking portion 26, or may be provided on both top and bottom surfaces thereof. By enlarging the region where the bead is included, or increasing the number of beads, the rigidity of the attachment member 20, in particular, the rigidity of the region where the bead is provided can be enhanced.

A brake support portion 28, which is at the substantially middle position, within the left side attachment member 21, located between the middle frame fastening portion 24 and the frame coupling member 13 in the front to back direction, is provided above the middle flange portion 23b, and includes a through hole passing through in the right and left direction.

The brake support portion 28 couplingly pivotally supports a brake drive shaft 61 extending in the right and left direction of the height brake 60, by the brake drive shaft 61 being inserted in the through hole.

In the left side attachment member 21, a cutout 29 is provided in a region, within the periphery of the member, located below the spring locking portion 26.

Specifically, within the left side attachment member 21, a region where the front frame fastening portion 25 is included is located outward in the right and left direction, and the middle frame fastening portion 24, a region where the frame coupling member 13 is coupled, a region where the spring locking portion 26 is included, and a region where the brake support portion 28 is included, are located inwardly therein.

When the seat cushion 3 is lifted and lowered by the height link mechanism 5, the middle frame fastening portion 24, a region where the frame coupling member 13 is coupled, a region where the spring locking portion 26 is included, and a region where the brake support portion 28 is included can change as appropriate their positional relationships in the right and left direction, within the range in which constituent elements do not interfere with each other.

As shown in FIG. 3, in the left side attachment member 21, a step surface portion is separately provided between the middle frame fastening portion 24 and the brake support portion 28, and above the spring locking portion 26. The step surface portion is made up of a bending shape formed in the right and left direction, and extends in the up to down direction. For that reason, the region where the middle frame fastening portion 24 is included, the region where the spring locking portion 26 is included, and the region where the brake support portion 28 is included, are located close to a region where the step surface portion is included, thus resulting in higher rigidity.

The right side attachment member 30, which is bent in the form of a crank as shown in FIG. 4, is formed such that the front side portion protrudes more inward in the right and left direction than the rear side portion, via a step surface portion 31 bent in the neighborhood of the rear end portion in the front to back direction. Further, via a step surface portion 32 bent substantially in the middle in the up to down direction, the lower portion is formed to protrude more inward in the right and left direction than the upper portion.

The right side attachment member 30 includes a rear frame fastening portion 33 and a front frame fastening portion 34 for coupling thereto the right side frame 11b, and a spring locking portion 35 for coupling thereto the right end portion of the first elastic member 14a.

The rear frame fastening portion 33, which is provided at the rear end portion of the right side attachment member 30, is caused to abut against the inside surface of the right side frame 11b and secured by laser welding.

The front frame fastening portion 34, which is provided at the front side upper end portion of the right side attachment member 30, is caused to abut against and is secured by laser welding to a recess, depressed inward in the right and left direction, that is on the inside surface of the left side frame 11b.

As described above, that the rear frame fastening portion 33 and the front frame fastening portion 34 may be coupled by another welding securement, or may be coupled in an easy-to-disassemble manner by a fastening bolt.

The spring locking portion 35 is provided at the end portion, within the right side attachment member 30, located below the front frame fastening portion 34, and includes a bend, bent in the right and left direction, that protrudes inward in the right and left direction.

The spring locking portion 35 is coupled to the first elastic member 14a by causing the right side end portion of the first elastic member 14a to be inserted in and hooked to a region surrounded by the bend, in other words, the through hole passing through in the front to back direction.

The right side attachment member 30 includes a bead 36 of projection shape protruding upwardly from the top surface of the spring locking portion 35. As described above, a region where the bead is included may be enlarged, or the number of beads may be increased.

Speaking specifically, within the right side attachment member 30, a region where the rear frame fastening portion 33 is included is located outward in the right and left direction, a region where the front frame fastening member 34 is included is located inwardly therein, and the spring locking portion 35 is located further inwardly therein.

Within the range in which constituent elements do not interfere with each other when the seat cushion 3 is lifted and lowered by the height link mechanism 5, their positional relationships in the right and left direction may be changed as appropriate.

The links 40, which are members that enable adjustment of the height level of the seat cushion 3, are attached to the right and left inside surfaces of the right and left side frames 11, and are constituted of four links, as shown in FIG. 2, the right and left front links 41 located at the front end portions of the right and left side frames 11, and the right and left rear links 50 located at the rear end portions thereof.

Each front link 41, which is of a substantially L-shaped sheet metal member, includes a first link drive portion 42, a second link drive portion 43, and a link coupling portion 44, as shown in FIG. 2.

The first link drive portion 42, which is provided at the lower end portion of each front link 41, is rotatably coupled to and pivotally supported by a support portion provided to protrude upwardly, the support portion being at the front end portion of the upper rail 4b.

The link drive portion 43, which is provided at the rear end portion of each front link 41, is rotatably coupled to and pivotally supported by the right and left inside surfaces, each being at the front end portion of each side frame 11.

The link coupling portion 44, which is provided at the front end portion of each front link 41, which is couplingly supported by a link coupling pipe 45 of substantially circle shaped cross-section. When each front link 41 rotates, both integrally rotate.

Each rear link 50, which is a sheet metal member having a different shape, is made up of the left rear link 51 shown in FIG. 3, and the right rear link 52 shown in FIG. 4.

The left rear link 51, which is of a substantially L-shaped drive link, is disposed between the left side frame 11a and the attachment member 20 in the right and left direction, as shown in FIG. 3.

The left rear link 51 includes a first link drive portion 53, a second link drive portion 54, and a sector gear portion 55, as shown in FIG. 3.

The right rear link 52, which is slender, substantially rectangle-shaped, includes the first link drive portion 53, and the second link drive portion 54, as shown in FIG. 4.

The shapes of the left rear link 51 and the right rear link 52 are not limited to these ones, but may be changed as appropriate.

The first link drive portion 53, which is provided at the lower end portion of each rear link 50 is rotatably coupled to and pivotally supported by a support portion provided to protrude upwardly, the support portion being at the rear end portion of the upper rail 4b.

The second link drive portion 54, which is provided at the rear end portion of each rear link 50, is rotatably coupled to and pivotally supported by the right and left inside surfaces, each being at the rear end portion of each side frame 11.

The sector gear portion 55, which is formed, as a gear, in a portion of its periphery of the left rear link 51, is engaged with a pinion gear 56 that is disposed in front of the sector gear portion 55.

The pinion gear 56, which is gear-shaped, is disposed between in the right and left direction the left side frame 11a and a region, within the attachment member 20, where the brake support portion 28 is provided.

Since the sector gear portion 55 and the pinion gear 56, of the left rear link 51 are thus disposed between the left side frame 11a and the attachment member 20 in the right and left direction, the sector gear portion 55 and the pinion gear 56 are effectively supported by the side frame 11a and the attachment member 20 even when a load is applied that attempts to tilt them in the right and left direction.

Further, since the attachment member 20 includes the rear flange portions 23c at a place opposite the left rear link 51 in the right and left direction, the left rear link 51 and the sector gear portion 55 are effectively supported by a region, within the attachment member 20, where the high rigidity rear flange portions 23c are provided.

The middle portion of the pinion gear 56 is provided with a through hole that passes in the right and left direction through the portion. Inserted through the through hole is the brake drive shaft 61, extending in the right and left direction, of a substantially circular shaped cross-section.

The pinion gear 56 is coupled via the brake drive shaft 61 to an operating lever 57 disposed outward in the right and left direction of the left side frame 11a, and the operation of the operating lever 57 rotates the brake drive shaft 61 as a rotation shaft.

In other words, when the operating lever 57 is operated, the pinion gear 56 rotates integrally with the brake drive shaft 61, causing position change of engagement of the pinion gear 56 with sector gear portion 55. Further, the left rear link 51 in which the sector gear portion 55 is formed rotates, the right rear link 52 and each front link 41 also rotates by being driven by the left rear link 51.

This causes the vehicle seat S body including the seat cushion 3 to be lifted and lowered, resulting in the height level of the seat being adjusted.

The height link mechanism 5 includes a mechanism in which a drive force produced by the operating lever 57 is transferred to the pinion gear 56, thereby rotating the left rear link 51, and further includes the height brake 60 that controls rotation of the pinion gear 56.

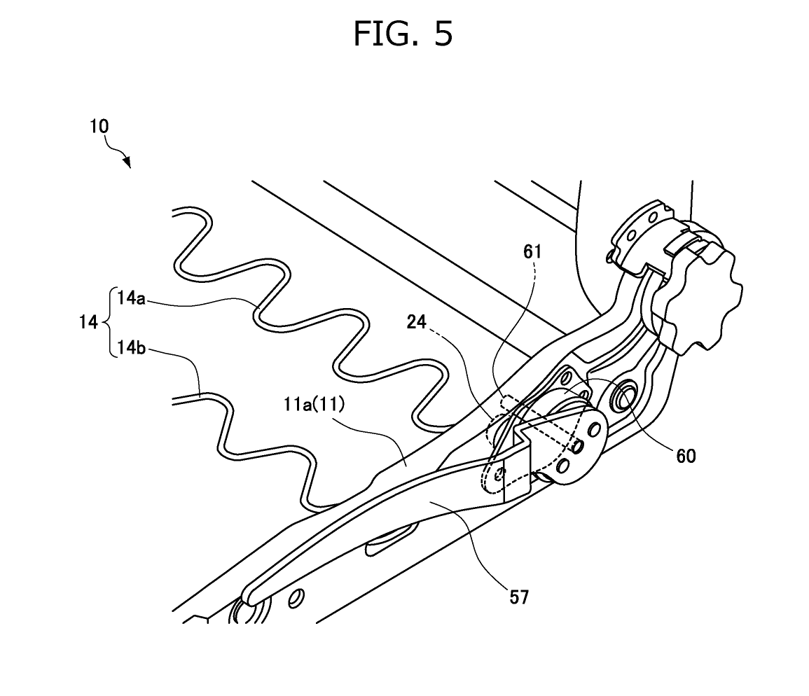

The height brake 60, which is made up of a known brake pinion member, is disposed between the left side frame 11a and the operating lever 57 in the right and left direction, as shown in FIG. 5.

The height brake 60 is joined to the outside surface in the right and left direction of the left side frame 11a. Within the height brake 60, a region joined to the left side frame 11a is provided astride in the front to back direction the recess secured to the middle frame fastening portion 24 in the inside surface of the left side frame 11a. Speaking specifically, within the height brake 60, the region joined to the left side frame 11a includes joining places within the left side frame 11a, located in front of and in back of the recess secured to the middle frame fastening portion 24.

In the present embodiment, within the height brake 60, the region joined to the left side frame 11a includes joining places, within the left side frame 11a, located in front of and in back of the recess secured to the middle frame fastening portion 24, but without being limited to this, it may be changed. For example, joining places may be provided along the entirely around the periphery of a region, within the height brake 60, joined to the left side frame 11a, or alternatively, joining places may be provided above and below the recess, within the left side frame 11a, secured to the middle frame fastening portion 24.

The height brake 60 includes in its middle portion the brake drive shaft 61 that extends in the right and left direction; the inside end portion from right and left of the brake drive shaft 61 is couplingly supported in a region, within the attachment member 20, where the brake support portion 28 is provided; and the outside end portion from right and left of the brake drive shaft 61 is couplingly supported by the operating lever 57.

More specifically, the brake drive shaft 61 is disposed to be couplingly pivotally supported by the middle portion of rotation of the operating lever 57, the height brake 60, the left side frame 11a, the pinion gear 56 and the brake support portion 28 of the attachment member 20, in the order from the outside toward the inside in the right and left direction.

The height brake 60 has a mechanism, not shown, that keeps the operating lever 57 in neutral during non-operation of the operating lever 57, applies a friction brake to the brake drive shaft 61 to control its rotation, and retains the height of the seat.

On the other hand, the height brake 60 has a mechanism, not shown, that increases a drive force produced by the operating lever 57 during operation of the operating lever 57, and controls a torque so that a great drive output can be provided to the brake drive shaft 61 by way of a small force, to cause the pinion gear 56 to rotate.

In the present embodiment, it is configured that the attachment members 20 are each attached on the inside surface of each of the right and left frames 11, and the first elastic member 14a is coupled to the right and left side frames 11 via the right and left attachment members 20.

By thus providing the attachment 20 to the side frame 11 of the vehicle seat S that includes the height link mechanism 5, the elastic member 14 is enabled to be disposed at an optimal location for supporting a seated passenger from below without interference of the elastic member 14 with the height link mechanism 5.

Specifically, both right and left end portions of the elastic member 14 are locked to the attachment members 20, thereby resulting in the portions being shifted inwardly from the right and left sides.

For that reason, when the seat cushion 3 is lifted and lowered by the height link mechanism 5, the elastic member 14 can be disposed in an offset position in order to avoid its interference with the link 40 and the pinion gear 56. Accordingly, the freedom of placement of the elastic member 14 is increased within the range of the insides of the right and left side frames 11.

It should be understood that in each of the above described embodiments, a front seat of an automobile has been described as a specific example, but without being limited to this, a middle seat and a rear seat of an automobile are also applicable.

### REFERENCE NUMERALS

S vehicle seat
1 seat back
1a, 2a, 3a cushion pad
1b, 2b, 3b skin
2 headrest
3 seat cushion
4 rail mechanism
4a lower rail
4b upper rail
5 height link mechanism
10 cushion frame
11 side frame
11a left side frame
11b right side frame
12 pan frame
12a bend
13 frame coupling member
14 elastic member
14a first elastic member
14b second elastic member
20 attachment member
21 left side attachment member
22 step surface portion
23 flange portion
23a front flange portion
23b middle flange portion
23c rear flange portion
24 middle frame fastening portion
25 front frame fastening portion
26 spring locking portion
27 bead
28 brake support portion
29 cutout
30 right side attachment member
31, 32 step surface portion
33 rear frame fastening portion
34 front frame fastening portion
35 spring locking portion
36 bead
40 link
41 front link
42, 53 first link drive portion
43, 54 second link drive portion
44 link coupling portion
45 link coupling pipe
50 rear link
51 left rear link
52 right rear link
55 sector gear portion
56 pinion gear
57 operating lever
60 height brake
61 brake drive shaft
100 side frame
101 rear link
102 right rear link
103 sector gear portion
104 pinion gear
105 operating lever
106 height brake
107 support arm
108 front portion
109 rear portion
110 middle portion

1. A vehicle seat comprising:
a height link mechanism that liftably and lowerably couples a seat cushion to a support base attached to a vehicle body;
wherein:
the seat cushion comprises:
a side frame disposed at both its right and left ends; and
a cushion frame that has a frame coupling member coupling the right and left side frames together;
the height link mechanism comprises:
a link that couples the support base and the side frame together, and
a height brake that controls lifting and lowering of the seat cushion;
an attachment member including a brake support portion that supports a drive shaft of the height brake is attached to the right and left insides of the side frame; and
in the attachment member, a region located in back of the brake support portion is a region supported by the frame coupling member, and a frame fastening portion fastened to the right and left insides of the side frame is provided in a region located in front of the brake support portion.

2. The vehicle seat according to claim 1, wherein:
the attachment member includes a flange portion that protrudes inward in a right and left direction in a region where the frame fastening portion is included and a region that is located below as viewed from the brake support portion;
the flange portion comprises:
a first flange portion; and
a second flange portion having a smaller amount of protrusion extending inward in the right and left direction than the first flange portion; and
the first flange portion is provided below the region where the frame fastening portion is included; and
the second flange portion is provided below the brake support portion.

3. The vehicle seat according to claim 1, wherein:
the frame fastening portion comprises
a first frame fastening portion; and
a second frame fastening portion, and
the attachment member includes the first frame fastening portion that is fastened to the side frame, between the second frame fastening portion and the frame coupling member in front to back direction.

4. The vehicle seat according to claim 1, wherein:
the link includes a sector gear portion in at least a portion of its periphery; and
wherein the attachment member includes a third flange portion protruding inward in the right and left direction, at a position opposite the sector gear portion in the right and left direction.

5. The vehicle seat according to claim 3, wherein an upwardly protruding bead of projection shape is provided below as viewed from the brake support portion and the first frame fastening portion.

6. The vehicle seat according to claim 1, wherein:
within the side frame, a region fastened to the frame fastening portion is depressed inward in the right and left direction and formed into a recess;
the height brake is joined to the side frame on the side opposite the frame fastening portion in the right and left direction; and
within the height brake, a region joined to the side frame is located astride the recess.

7. The vehicle seat according to claim 1, wherein the attachment member is attached between the upper end and the lower end of the side frame.
